(19) United States
(12) Patent Application Publication
(10) Pub. No.: US 2016/0285495 A1
(43) Pub. Date: Sep. 29, 2016

(54) Wireless Multimode Charging Center

(71) Applicant: MagSOL Labs, Morton Grove, IL (US)

(72) Inventors: Ronald A. Vick, Morton Grove, IL (US); Robert Pozdal, Inverness, IL (US)

(21) Appl. No.: 15/072,868

(22) Filed: Mar. 17, 2016

Related U.S. Application Data
(60) Provisional application No. 62/138,077, filed on Mar. 25, 2015.

(51) Int. Cl. H04B 1/3883; H02J 7/35; H02J 7/02; H04M 1/725

(52) U.S. Cl. CPC H04B 1/3883; H04M 1/7253; H02J 7/355; H02J 7/025

(57) ABSTRACT

A charger system for cell phones and the like provides an easel stand supporting the cell phone and a photocell for an optimal charging with the photocell substantially perpendicular to the direction of the sun. A wireless charging coil built into the easel allows power to be communicated from the photocell and an internal storage battery to the phone as supported on the easel.

### CROSS REFERENCE TO RELATED APPLICATION

This application claims the benefit of U.S. provisional application 62/138077 filed Mar. 25, 2015, and hereby incorporated in its entirety by reference.

### BACKGROUND OF THE INVENTION

The present invention relates to a charging system for portable devices such as cell phones and the like and in particular to a multimode charging system providing wireless charging.

“Smart” portable electronic, devices such as smart phones and tablets (henceforth “smart devices”) can be a boon to the traveler, providing tier communication, photography, navigational assistance, language translation and Internet connectivity in a compact form factor that is easily accessible. A significant limitation, however, is the limited battery life of such devices, particularly when GPS navigation or cellular communication is required. Running out of power while traveling can be a major inconvenience, particularly in environments where electrical outlets are scarce including both in remote areas and many public spaces.

Supplemental external battery packs can provide a limited solution so long as the battery packs are charged and the traveler will be in a position to recharge the battery packs and can remember to recharge the battery packs after use Frequently, external battery packs are charged through a charging cord that is shared with the smart device and as a result are rendered useless if the charging cord is lost or misplaced. When a single charging cord is shared, in order to avoid the need to track and carry two cords, the user must remember to sequentially recharge the battery pack and smart device one at a time when returning to a hotel room or the like.

Battery packs may be combined with solar panels to address the problem of the traveler running out of power. Practically sized solar panels are generally relatively inefficient as currently implemented and effectively prevent use of the cell phone during the charging process.

### SUMMARY OF THE INVENTION

The present invention provides a supplemental external battery with a solar panel that provides an easel structure allowing the solar panel to be properly oriented with respect to the sun (approximately normal to the angle of the sunlight) while supporting the cell phone for use. A wireless recharging coil eliminates the need for multiple cables or sequential recharging steps and operates as a wireless charger as well to permit another source of energy replenishment from wireless charging stations. A standard electrical connector exists both for charging and providing power to a cell phone.

The invention may further fold flat to provide a wireless charging surface on which the smart device may be placed in a hotel room or the like to simultaneous charge the external battery and the smart device.

Specifically, the invention provides a recharging system for wireless telephones having an easel with a first and second support panel joined at upper edges by a hinge so that the first and second support panels may move together to be substantially parallel and may move apart to stably support the easel on a horizontal surface on lower edges of the first and second support panel opposite the upper edges. A cell phone attachment is provided for releasably holding a cell phone against a supporting surface of one of the first and second support panels, the supporting surface being exposed both when the first and second support panels move together and move apart. A battery having a capacity of at least 1000 milliamp hours is held by one of the first and second support panels and a photocell is supported on a sun reception surface of at least one of the first and second support panels, the sun reception surface exposable to the sun both when the first and second support panels move together and move apart, the photocell electrically connected to the battery to provide electricity to the battery when the photocell is exposed to the sun.

It is thus a feature of at least one embodiment of the invention to provide a cell phone charger that permits maximization of energy harvesting while the phone is in use by opening an easel frame which may then close for convenience when charging is not required.

The hinge may provide an angular separation between the first and second support panels of no less than 50 and/or greater than 60 degrees.

It is thus a feature of at least one embodiment of the invention to permit the easel to properly position the solar panel at an efficient angle for solar collection.

The recharging system may further include a wireless energy-transmitting coil adjacent to the supporting surface for wirelessly communicating energy to a phone attached to the recharging system with a cell phone attachment.

It is thus a feature of at least one embodiment of the invention to provide convenient recharging of a phone without the need for separate cables which can be lost or damaged.

The recharging system may include a wireless energy-receiving coil adjacent to the supporting surface for wirelessly receiving energy from an external wireless charging system.

It is thus a feature of at least one embodiment of the invention to permit energy reception from a variety of sources including the sun, and wireless charging stations when available.

The cell phone attachment may be a co-adhesive surface.

It is thus a feature of at least one embodiment of the invention to provide an attachment which means it works with a variety of different phones of different sizes and aspect ratios.

Alternatively, the cell phone attachment may be a set of clamps gripping the sides of the cell phone.

It is thus a feature of at least one embodiment of the invention to provide a charging station that can essentially operate as a cell phone case continuously and robustly attached to the cell phone.

The recharging system may also include an electrical connector and a voltage control circuit communicating between the battery and the electrical connector to provide power to the electrical connector from the battery.

It is thus a feature of at least one embodiment of the invention to permit direct charging of the phone through a cable if required.

The recharging system may further include an electrical connector electrically communicating with the battery to receive power at the electrical connector to provide that power to the battery.

It is thus a feature of at least one embodiment of the invention to permit standard charging of the battery through a cable if required.

The first and second supports panels are substantially rectangular and the lower edges of the first and second support panel are substantially parallel both when moved together and apart.

It is thus a feature of at least one embodiment of the invention to provide an efficient shape and size for supporting a photocell and containing an internal battery.

In one embodiment, one of the first and second support panel supporting the photocell may also hold at least one extendable panel moving between a closed position substantially parallel to the photocell and behind the photocell and an open position substantially parallel to the photocell but displaced to the side of the photocell to expose a face supporting an additional photocell. The photocell and the additional photocell may both be electrically connected to the battery to provide electricity to the battery when the photocell and additional photocell are exposed to the sun.

It is thus a feature of at least one embodiment of the invention to practically increase the light gathering power of the photocells while still providing a compact form factor for travel and storage.

The recharging system may further include at least one audio speaker held within one of the first and second support panels and communicating with a wireless receiver to receive audio signals through the wireless receiver from a cell phone supported against the supporting surface.

It is thus a feature of at least one embodiment of the invention to provide an improved power source and speaker supporting area for a cell phone allowing it to be used to play music without the need for earphones or the like and without undue drain on the battery of the cell phone.

These particular objects and advantages may apply to only sonic embodiments falling within the claims and thus do not define the scope of the invention.

### BRIEF DESCRIPTION OF THE DRAWINGS

FIG. 1 is a pair of perspective views of the housing of the wireless multimode charging center of the present invention in an unfolded easel configuration viewed from two different orientations, showing support of a smart phone on one surface of the easel and the support of the solar panel on the opposite surface of the easel;

FIG. 2 is a fragmentary view of a hinge of the housing in folded and easel configurations showing a stop providing a stable opening of the housing for improved alignment of the solar panel with the sun;

FIG. 3 is an exploded fragmentary view of the wireless multimode charging center with the smart device-supporting side facing upward, showing an adhesive surface that may engage a corresponding adhesive surface on the smart device and showing corresponding wireless charging elements in the smart device and the charging center, the latter communicating with a power management printed circuit board;

FIG. 4 is an electrical block diagram showing the principal circuitry elements of the present invention in providing multiple charging and recharging modes;

FIGS. 5a and 5b are side elevational views of a smart device placed against the wireless multirnode charging center and showing flexible standoffs that prevent adhesive engagement between the smart device and charging center before proper alignment;

FIG. 6 is a perspective fragmentary view of the charging center in a folded configuration for simultaneous charging of an internal battery and the smart device as a wireless charging surface:

FIG. 7 is a figure similar to that of FIG. 1 showing use of clamping surfaces for holding the cell phone in the manner of a cell phone case;

FIG. 8 is a front view of the solar panel as supported on the easel showing an opening allowing use of the camera when the easel is closed;

FIG. 9 is a figure similar to FIG. 2 but showing only the unfolded easel configuration and an embodiment including nested sliding solar panels; and

FIG. 10 is a figure similar to that of FIG. 1 showing the sliding solar panels in extended form and a speaker configuration.

### DETAILED DESCRIPTION OF THE PREFERRED EMBODIMENT

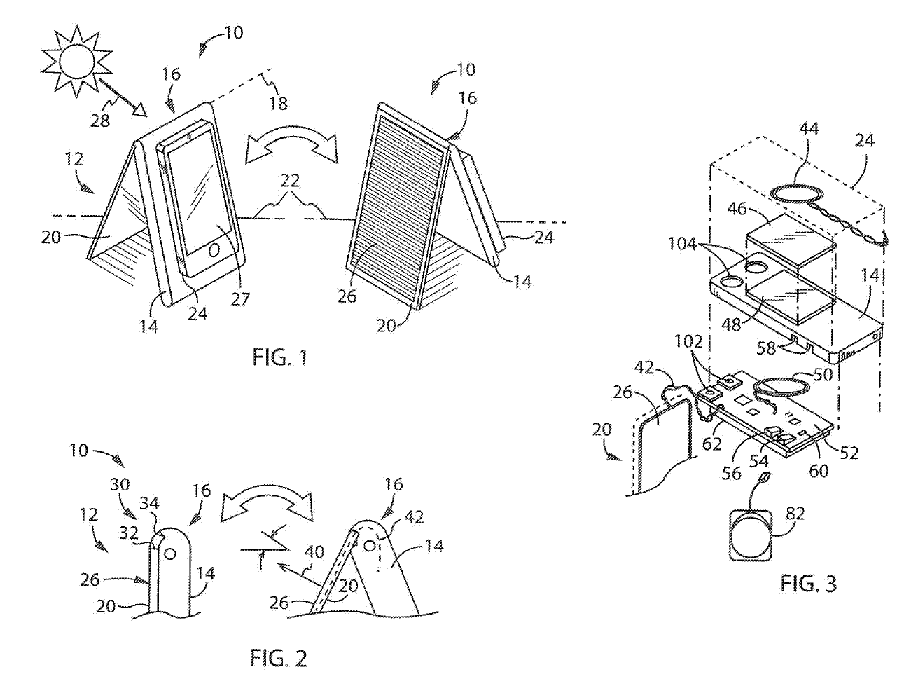

Referring now to FIG. 1, a wireless multimode charging center 10 constructed in accordance with the present invention may provide for an easel structure 12 providing two planar arms 14 and 20 attached at their upper edges by a hinge 16 to pivot about axis 18 with respect to each other. In the unfolded configuration, as shown, the lower edges of the arms 14 and 20 are spaced apart providing edges that define a common plane to support the easel structure 12 stably on a horizontal surface 22.

An outer face of the arm 14 provides a generally planar surface that may abut a rear face of a smart device 24 such as a smart phone or the like and retain the smart device 24 against sliding with respect to the arm 14 by an adhesive or other releasable interconnection as will be discussed below. As so supported, a user screen 27 of the smart device 24 is accessible and conveniently supported for the user.

The outer face of arm 20 also provides a generally planar surface covered by a solar cell 26 to be exposed to the receipt of solar radiation 28 for the generation of electrical power.

Referring now to FIG. 2, the hinge 16 may provide for an angular stop 30 limiting the angle by which the arms 14 and 20 may be separated by rotation by means of an abutting of stop surface 32 on arm 20 against stop surface 34 on arm 14. Ideally this angle will be chosen to permit a surface normal 40 of an exposed face of the solar cell 26 to be directed at an average elevation of the sun during the hours around midday for a given season and latitude. An angular opening of more than 50 degrees and no less than approximately 60 degrees is suitable for this purpose in North America. Proper alignment of the solar cell 26 can increase its output by 30 percent.

When the easel structure 12 is in the folded configuration with arms 20 and 14 parallel and abutting, the wireless multimode charging center 10 may be slipped into a pocket or easily placed in luggage or may be placed with the arm 14 downward against a horizontal surface and the arm 20 upward so that the solar cell 26 will face upward for low efficiency charging. Alternatively and as will be discussed below, the orientation of the wireless multimode charging center 10 may be inverted with the solar cell 26 facing downward to provide a wireless charging pad with a wireless multimode charging center 10 supported on a table or the like indoors.

It will be appreciated that either one of the stop surfaces 32 and 34 may be adjustable and may provide a gnomon or the like to allow the user to make an appropriate adjustment to a range of different angles. In one embodiment a set of mechanical detent positions may be provided or suitable frictional interference for this adjustment and the stop surfaces 32 and 34 may prevent overextension. Electrical power conductors 42 may extend between the arms 20 from the solar cell 26 through the hinge 16 to circuitry within the arm 14 to prevent the exposure of any wiring.

Referring now to FIG. 3, the smart device 24 may employ a wireless charging coil 44 either internal to the smart device 24 or attached to a rear surface of the smart device 24 using a dongle type charging attachment and conforming to any of a number of wireless charging standards including, for example, those of the A4WP (Alliance for Wireless Power), PMA (Power Matters Alliance) or (WPC) Wireless Power Consortium, such standards generally available to the public and hereby incorporated by reference.

A releasable adhesive material 46 may cover a portion of the rear surface of the smart device 24 to allow adhesive attachment to a corresponding adhesive material 48 positioned on the exposed face of the arm 14. The adhesive material 46 may be a conventional co-adhesive with low tack that relies on viscoelasticity to permit multiple repeated use or may be a material such as Geckskin™ or other micro structured surface employing draping adhesion or may be a micro suction material. Alternatively a high friction soft elastomer such as polyurethane or polydimethylsuloxane or mechanical retention means such as snaps or clips may be employed. As will be discussed below, clips or sidewalls may engage the sides of the phone, for example, in the manner of a phone case, clamping the phone between the clips or sidewalls. In this implementation, the system of the present invention can be incorporated into a cell phone case routinely holding the cell phone during use and charging. In one embodiment adhesive material 48 is selected to hold the smart device 24 without the need for material 46.

Positioned within a housing forming the second arm 14 is a corresponding wireless transmission coil 50 that may wirelessly transmit power to the wireless charging coil 44 as driven by a circuit card 52. The circuit card 52 may be a printed circuit board holding a charging electrical connector 54 and a recharging electrical connector 56. Both electrical connectors 54 and 56 maybe, for example, USB type connectors exposed through corresponding openings 58 in the housing of the arm 14. The invention contemplates that any of a wide variety of different USB type connectors may be used including USB Type A, USB Type B, USB Mini-A, USB Mini-B, USB Micro-A, USB Micro-B, USB Micro-AB, USB Type-C. These examples are nonlimiting and other types of electrical connections including. For example, the “lightning” connector used by Apple Computer, may be used.

The recharging electrical connector 56 may connect with a wireless dongle 82 to allow wireless recharging through the electrical connector 54. In one embodiment the wireless dangle 82 may be incorporated into the arm 20 to provide yet another option for recharging the charging center 10 by placing the solar cell 26 downward on a wireless recharging station.

A rechargeable battery 62, fur example, one or more lithium polymer cells or lithium ion cells, may also be held in the housing of the arm 14 having a capacity suitable to provide no less than a full recharge of a standard smart device 24 through the wireless charging circuitry. Because of some efficiency loss in wireless charging and the desire for reserve capacity, the capacity of the battery 62 will be essentially larger than that of the battery of the smart device 24. Generally the battery 62 will have a capacity of greater than 1000 milliamp hours and preferably greater than 2000 milliamp hours.

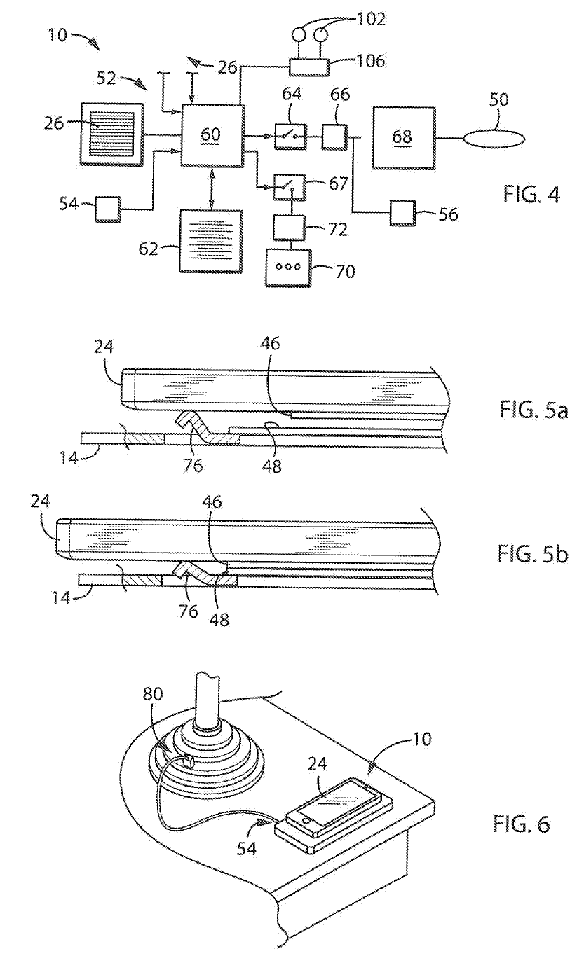

Referring now to FIG. 4, either or both of the solar cell 26 and charging electrical connector 54 may provide electrical power to a battery management circuit 60 on the circuit card 52. Such circuits, such as are known in the art and provide controlled charging and discharging of associated chemical batteries, fur example, lithium polymer batteries 62, are intended to maximize the life of such batteries. Nonlimiting examples of an integrated circuit suitable for this purpose include the MAX77301 integrated lithium charger available from Maxim Integrated of San Jose, Calif.

Discharge of the battery 62 may also be handled by the battery management circuit 60 which provides power through a low power consumption switch 64 to a boost converter 66 boosting the voltage from the battery voltage of battery 62 into a high-voltage necessary for wireless charging circuitry 68. When low power consumption switch 64 is in the “off” position there is no standby power consumed by the boost converter 66 (because it is switched off) which allows for extremely efficient solar power or line power charging. A boost converter suitable for use with the present invention is the MAXI 7503 also available from Maxim Integrated.

As is generally understood in the art, the wireless charging circuitry 68 converts a high-voltage DC signal into an AC signal that may be wirelessly transferred through transmission coil 50. Charging coil 44 receives this AC signal which is full-wave rectified and applied to the battery of the smart device 24. The output of the boost converter 66 may also be applied to connector 56 to permit a direct electrical connection between connector 56 and a charging port of the smart device 24 through an appropriate cable if a cable is available. In one embodiment, the boost voltage is five volts to meet the USB/AC charger power standards for USB connected smart devices 24.

It will be appreciated that a standard wireless charging “dongle” may be connected to charging electrical connector 54 to allow charging of the battery 62 using other wireless charging system outputs, for example, those that are publicly available at locations such as Starbucks or built into furniture manufactured by IKEA.

The battery management circuit 60 may also communicate with visual displays 70, for example, one or more LEDs which provide an indication of the status of the battery 62 and various charging modes. This communication may be provided through a battery fuel gauge circuit 72, for example, an integrated circuit available from Maxim Integrated sold under the trade designation of “Model Gauge Battery Fuel Gauge”. The battery management circuit 60 may communicate with the fuel gauge circuit 72 through a low power consumption switch 67.

Data sheets for all of the above-described, integrated circuits are hereby incorporated by reference.

Low power consumption switches 64 and 67 may be, fur example, bistable mechanical switches that consume no power in either switch state or may be solid-state devices such as MOs transistors that provide low consumption during either an on or off state that will not adversely affect the charge of the battery 62.

Referring now to FIGS. 5a and 5b, an outer surface of arm 14 for supporting the smart device 24 may include spring-loaded standoffs 76 that extend away from that surface to contact a rear face of the smart device 24 so as to hold the adhesive materials 48 and 46 in separation until proper alignment of the arm 14 and smart device 24 is obtained such as would aligned coils 44 and 50 shown in FIG. 3. At that time, additional inward pressure by the user may retract the standoffs 76 so that adhesive materials 46 and 48 retain themselves in contact against the force of the standoff 76. In this way proper positioning of the smart device 24 can be obtained without interference from the adhesive qualities of adhesive materials 46 and 48 ensuring proper coil alignment. The spring-loaded standoffs 76 provide a “retractable feature” allowing the device to be oriented properly before making contact with holding surfaces of adhesive materials 46 or 48.

Referring now to FIG. 6, as noted above, when the wireless multimode charging center 10 is in the folded configuration, charging electrical connector 54 may be used to connect the wireless multimode charging center 10 to a source of electrical power 80 while the smart device 24 is supported against the arm 14 for wireless charging and the solar cell 26 is lying flat against the table. The charging electrical connector 54 may be also used in the easel configuration.

It will also be appreciated that smart device 24 may be charged with the system in an easel configuration, for example, as shown in FIG. 1, allowing the smart device 24 to be visible to the user for use as an alarm clock or the like. Power from the solar cell 26 may be augmented with power through the electrical connector 54 when such circumstances permit. Generally, wireless charging of the smart device 24 may occur through the use of battery power while offsetting the current drain from the battery with power from the solar cell 26.

It will also be understood that any time the wireless multimode charging center 10 is in the folded state, it may be placed with the solar cell 26 upward to receive residual charge from solar energy, for example, on the dashboard of a car or the like.

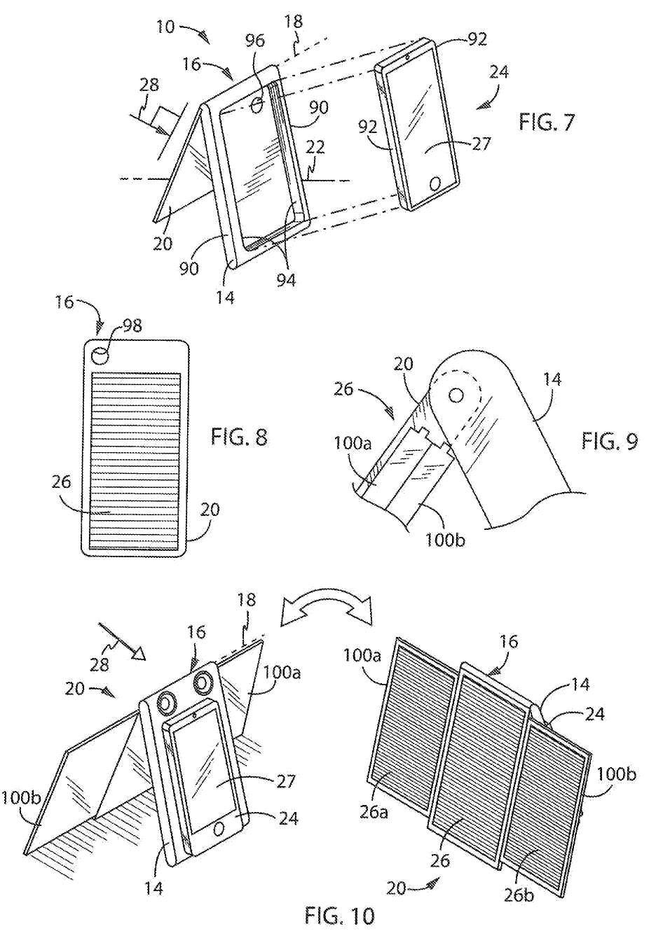

Referring now to FIG. 7, in an alternative embodiment, the area of the arms 14 and 20 may be closer to the outer dimensions of the smart device 24 so that the smart device 24 may be held by the arm 14 by means of projecting sidewalls 90 that may flex outward to receive the corresponding sidewalls 92 of the smart device 24 and to bold the smart device 24 on the arm 14 in the manner of a cell phone case. In this regard, the sidewalls 90 may have inwardly facing lips 94 at their distal edges that reach around the front of the smart device 24 to better retain it. The arm 14 may include elastomeric elements for shock reduction and the like in the manner of a conventional cell phone case.

Referring now also to FIG. 8, the solar cell 26 may be sized so as not to block an opening 96 in the arm 14 aligned with a camera on the rear face of the smart device 24 and a corresponding opening 98 aligned with opening 96 when the easel is closed with arms 14 and 20 substantially parallel and together.

Referring now to FIGS. 9 and 10, the rear side of the planar arm 20 may include sliding panels 100a and 100b on separate tracks formed in part by the planar arm 20. The tracks allow panels 100a and 100b to slide together within the periphery of arm 20 so that arm 20 and arm 14 may freely close to the folded configuration as discussed above and may separate into the unfolded configuration.

Conversely, the tracks allow the sliding panels 100a and 100b to slide apart to project laterally generally along axis 18 outward on either side of solar cell 26 to expose additional solar cells 26a and 261) respectively generally parallel the solar cell 26 but flanking either side of solar cell 26. The sliding panels 100a and 100b may approximately triple the solar collection area of the charging center 10.

Flexible conductors may connect the solar cells 26a and 26b to the battery management circuit 60 as discussed above with respect to FIG. 4 allowing free movement of the panels 100a and 100b inward and outward. Alternatively electrical contacts may be provided (not shown) engaging the solar cells 26a and 26b only when panels 100a and 100b are fully extended, it will be appreciated that the solar cells 26a and 26b are relatively thin and thus the thickness of the arm 20 may still be minimized.

Alternatively a hinging system may be used in which panels 100a and 100b are hinged at their outside edges to arm 20 to swing outward also to the position as shown in FIG. 10, In this case, the solar cells 26a and 26b will be mounted on the opposite sides of the panels 100a and 100b as would be the case with the sliding configuration. The planes of each of the solar cells 26, 26a and 26b are substantially parallel so that the easel structure equally provides the proper angle of incidence to the sun as has been described above.

Referring now to FIGS. 2, 3 and 10, the printed circuit card 52 may incorporate piezoelectric or electromagnetic speaker elements 102 beneath grill openings 104 in the arm 14 positioned above the adhesive material 48. As shown in FIG. 2, the speaker elements 102 may communicate with a Bluetooth receiver 106 receiving power from the battery management circuit 60 and able to communicate with the smart device 24 to play music through the speaker elements 102 from the smart device 24 powered by the battery management circuit 60. It will be appreciated that the speakers may be located in alternative locations, for example, on the rear side of panels 100a and 100b or the inside surface of arm 14 and angled outward so as to use panels 100 as a reflector or the like.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. ft is further to be understood that the method steps, processes, and operations described herein are not to be construed as necessarily requiring their performance in the particular order discussed or illustrated, unless specifically identified as an order of performance. ft is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. A recharging system for wireless telephones comprising:
an easel having a first and second support panel joined at upper edges by a hinge so that the first and second support panels may move together to be substantially parallel and may move apart to stably support the easel on a horizontal surface on lower edges of the first and second support panel opposite the upper edges,
a cell phone attachment for releasably holding a cell phone against a supporting surface of one of the first and second support panels, the supporting surface being exposed both when the first and second support panels move together and move apart, the supporting surface providing:
a battery having a capacity of at least 1000 milliamp hours held by one of the first and second support panels; and
a photocell supported on a sun reception surface of at least one of the first and second support panels, the sun reception surface exposable to the sun both when the first and second support panels move together and move apart, the photocell electrically connected to the battery to provide electricity to the battery when the photocell is exposed to the sun.

2. The recharging system of claim 1 wherein the hinge provides an angular separation between the first and second support panels of no less than 50 degrees.

3. The recharging system of claim 2 wherein the hinge provides an angular separation between the first and second support panels of greater than 60 degrees.

4. The recharging system of claim 1 further including a wireless energy transmitting coil adjacent to the supporting surface for wirelessly communicating energy to a phone attached to the recharging system with a cell phone attachment.

5. The recharging system of claim 1 further including a wireless energy-receiving coil adjacent to the supporting surface for wirelessly receiving energy from an external wireless charging system.

6. The recharging system of claim 1 wherein the cell phone attachment is a co-adhesive surface

7. The recharging system of claim 1 wherein the cell phone attachment is a set of clamps gripping the sides of the cell phone.

8. The recharging system of claim 1 further including an electrical connector and a voltage control circuit communicating between the battery and the electrical connector to provide power to the electrical connector from the battery.

9. The recharging system of claim 1 further including an electrical connector electrically communicating with the battery to receive power at the electrical connector to provide that power to the battery.

10. The recharging system of claim 1 wherein the first and second support panels are substantially rectangular and the lower edges of the first and second support panels are substantially parallel both when moved together and apart.

11. The recharging system of claim 1 wherein one of the first and second support panel supporting the photocell also holds at least one extendable panel moving between a closed position substantially parallel to the photocell and behind the photocell and an open position substantially parallel to the photocell but displaced to the side of the photocell to expose a face supporting an additional photocell; and wherein the photocell and the additional photocell are both electrically connected to the battery to provide electricity to the battery when the photocell an additional photocell are exposed to the sun.

12. The recharging system of claim 1 further including at least one audio speaker held within one of the first and second support panels and communicating with a wireless receiver to receive audio signals through the wireless receiver front a cell phone supported against the supporting surface.
